(19) United States
(12) Patent Application Publication
(10) Pub. No.: US 2019/0179778 A1
(43) Pub. Date: Jun. 13, 2019

(54) SYSTEM MEMORY CONTROLLER WITH CLIENT PREEMPTION

(71) Applicant: EXTEN Technologies, Inc., Austin, TX (US)

(72) Inventors: Daniel B. Reents, Dripping Springs, TX (US); Michael Enz, Fargo, ND (US); Ashwin Kamath, Cedar Park, TX (US)

(21) Appl. No.: 15/836,372

(22) Filed: Dec. 8, 2017

(51) Int. Cl. G06F 13/16; G06F 3/06; G06F 13/38

(52) U.S. Cl. CPC G06F 13/1626; G06F 3/0613; G06F 13/38; G06F 13/1689; G06F 13/1663

(57) ABSTRACT

A system memory controller and method are disclosed providing a client preemption feature allowing performance optimizations for control firmware in a systolic array. The preemption feature allows clients with very different performance requirements and traffic patterns to share a central memory subsystem with minimal blocking and response latency issues.

### TECHNICAL FIELD

The subject disclosure relates generally to computer software and hardware design. In particular the subject disclosure relates to system memory controller with client preemption.

### BACKGROUND

Typically, a system memory controller services several clients each with a diverse set of data transfer patterns. For example, some clients will typically transfer large bursts of data (i.e., 4 KB) to/from memory thus representing the most efficient and highest bandwidth transfers. Other clients, such as the system management processor, will typically generate smaller data burst transfers in order to service its local cache memory. Still other clients, such as embedded processing nodes, will generate many smaller write/read operations to/from the system memory in order to manipulate small pieces of meta-data or state variables.

With these diverse memory client operations, it is evident that clients that must manipulate small data structures within the system memory, such as an embedded processor, can incur significant latency such as when a large bulk transaction is occurring. In such a case, the small transaction client must wait to begin until the bulk transaction is complete.

### SUMMARY OF THE SUBJECT DISCLOSURE

The present subject disclosure presents an exemplary system memory controller providing a client preemption feature allowing performance optimizations for control firmware in a systolic array. The preemption feature allows clients with very different performance requirements and traffic patterns to share a central memory subsystem with minimal blocking and response latency issues.

In one exemplary embodiment, the present subject matter is a method for directing memory transactions. The method includes receiving a memory transaction request from a preemptor client; receiving a memory transaction request from a preemptee client; and proceeding with the memory transaction request of the preemptor client.

In another exemplary embodiment, the present subject matter is a memory transaction request from a preemptee client. The method includes receiving a memory transaction request from a preemptor client; receiving a memory transaction request from a preemptee client; wherein the preemptor clients and preemptee clients are predetermined; and wherein if the memory transaction request from the preemptee client was received first and being operated on when the memory transaction request from the preemptor client is received, then the memory transaction request from the preemptee client is ceased until the transaction request from the preemptor client is completed, and then transaction request from the preemptee client is continued.

In yet another exemplary embodiment, the present subject matter is a system for directing memory transactions. The system includes a plurality of client interfaces that receive memory transaction requests from a plurality of clients; and a plurality of access sequencers; wherein the access sequencers determine an order of transactions based on the client that sent the memory transaction request.

### BRIEF DESCRIPTION OF THE DRAWINGS

Various exemplary embodiments of this disclosure will be described in detail, wherein like reference numerals refer to identical or similar components or steps, with reference to the following figures, wherein:

FIG. 1 illustrates a block diagram showing preemptor and preemptee paths, according to an exemplary embodiment of the present subject disclosure.

### DETAILED DESCRIPTION

In a routine transaction, each client issues a descriptor to request a memory transfer. That descriptor includes details, such as, for example, a memory address, a length of the amount of data it would like to read or write, and other information. If it's a write, that client also provides the write data. So every client has a mechanism to request access to memory. The descriptor needs to be completed in its entirety before another client has access to that memory. A problem is created when some clients have long access to memory, and some clients have very short access to memory. The problem is that the client with the short access to memory would have to wait until the client with the long access to memory is done. This subject matter presents a technique that satisfies both types of clients.

To address the shortcomings of the conventional processes, it may be helpful to classify clients that preempt others as those that issue memory access requests that will block (i.e., stall) the processor until the request finishes. For example, processors that issue memory load requests to load a cache line of memory into a local cache need low latency access to memory, and stalls due to memory access will directly impact overall performance. Therefore, these clients should preempt others. These types of clients may be classified as “preemptors.”

In contrast, clients that are preemptible tend to be those transferring larger amounts of memory, or those that use an asynchronous interface to transfer the memory. In an exemplary systolic array according to the present subject disclosure, most clients use asynchronous message passing to access memory, allowing the clients to pipeline multiple requests. This makes a stall due to preemption manageable in firmware without hurting overall throughput. In this design it is better to preempt these clients with a stall to maximize the efficiency of the entire system. These types of clients may be classified as “preemptees.”

The exemplary embodiment described in the present subject disclosure includes two independent client arbitration groups. One group is classified as “preemptors” while the other is classified as “preemptees”. Within each of these groups any arbitration scheme can be implemented.

For example, clients that need large access to memory can be lumped together and put in one group, and clients that need short burst access to memory can be lumped into another, second group.

When a client in the preemptors group has won arbitration, it will assert its preemption request signal to the preemptees group. If the preemptees group is not actively servicing a memory transaction, it will acknowledge the preemptors group immediately thus allowing the client in the preemptors group to be serviced. The preemptors group will continue to assert its preemption request signal until no other clients in this group are requesting a transaction. During this time, the clients in the preemptees group will not be allowed to be serviced.

As previously discussed, when a client in the preemptors group has won arbitration, it will assert its preemption request signal to the preemptees group. If the preemptees group is actively servicing a memory transaction, it will cease the active servicing of the transaction and save the transaction state locally. At this point the preemptees group can acknowledge the preemptors group thus allowing the client in the preemptors group to be serviced. The preemptors group will continue to assert its preemption request signal until no other clients in this group are requesting a transaction. During this time, the clients in the preemptees group will not be allowed to be serviced. When all of the clients in the preemptors group are idle, this group will de-assert its preemption request signal and the “stalled” client in the preemptees group will be serviced from where it left off based on its saved operation state.

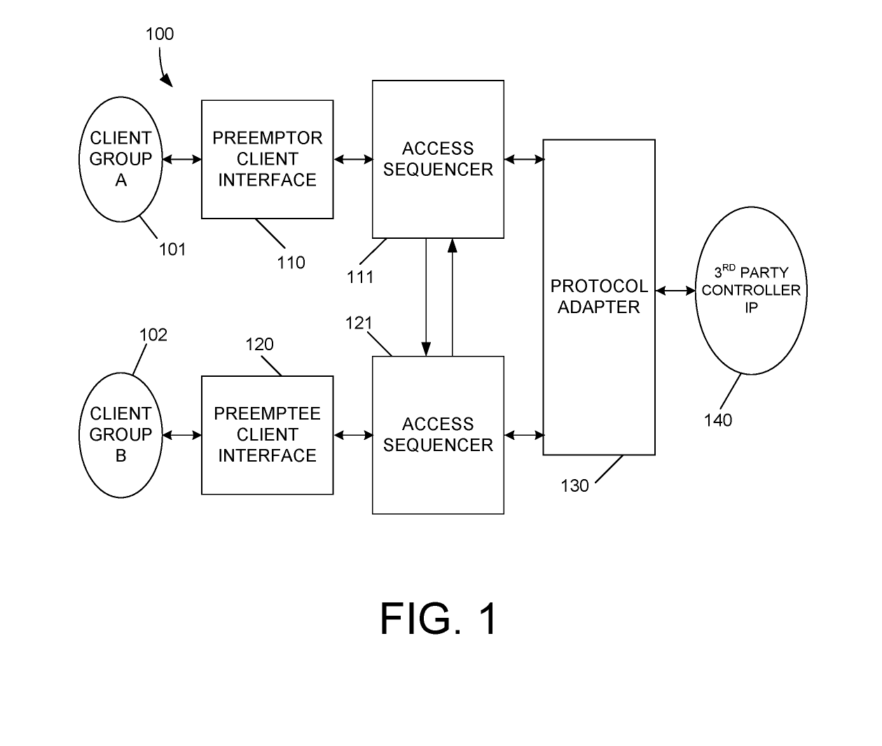

An exemplary block diagram of the subject disclosure is shown in FIG. 1. Each block is briefly described below. In essence, two different sequencers are being presented. As illustrated in the FIGURE, a system 100 according to the present subject disclosure includes a preemptor client interface 110 which accepts requests for memory transactions from a configurable number of clients 101 that may be required to perform preemption. A round robin arbitration scheme is employed to select a given client 101 request and a multiplexing and decode logic is employed to steer the selected client transaction request and response to/from the sequencer 111.

A preemptee client interface 120 accepts requests for memory transactions from a configurable number of clients 102 that may be preempted. A round robin arbitration scheme is employed to select a given client request and a multiplexing and decode logic is employed to steer the selected client transaction request and response to/from the sequencer. This block 120 may be identical to the preemptor client interface block 110 under certain circumstances. For example, if all of the client interface protocols, bus widths, etc., are the same.

The access sequencer 111 is responsible for decoding the selected client's descriptor and performing all memory transactions between the client 101 and the protocol adapter 130. This includes the performance of all data alignment operations. Each of the sequencers 111, 121 shown may be an identical hardware module. The module has a compile time parameter that can be set to configure the module to be a preemptor or a preemptee. When the sequencer 111 has completed the write or read access to the memory via the protocol adapter module 130, it will generate a response back to the requesting client 101 to complete the transaction.

The protocol adapter 130 is responsible for allowing the access sequencers 111, 121 to work with any 3rd party controller IP bus protocol 140. In order to support returning read data to the proper sequencer 111,121, a request/response tagging scheme may be utilized.

In operation, the technique according to the present disclosure provides two completely separate memory controller sequencers and allows a first access sequence servers (top one associated with Group A 101) to tell a second access sequencer (bottom one associated with Group B 102) that it wants to perform an operation so the second access sequencer should stop what it's doing. So then the second access sequencer acknowledges this request and confirms that it has stopped what it's doing to allow the first access sequencer access to the protocol adapter 130 to get its request in. And then when the first access sequencer is done with its transaction, it would tell the second access sequencer that it is done, and if there is anything pending, then the second access sequencer can pick up where it left off.

The present subject disclosure may have many uses and operations. For example, it may be used for the generation of a module level description defining the types of clients to be supported. Low level, micro-architecture document showing block level flow diagrams for the implementation may be used. Generation of Verilog RTL may be used to implement the design. Block level simulation may be used to verify the design and modify any issues found. Integration may be made into the top level design. System level simulation may be used. Standard back-end ASIC development process may be used to produce the targeted device.

Alternative uses are also possible and within the scope of the present disclosure. The micro architecture and implementation specific details have been defined in such a way as to allow additional client interfaces, data steering options, etc., to be added quickly and without protocol changes. In certain embodiments, the specific design is not directly dependent on any other 3rd party IP hardware blocks from a protocol or data bus width perspective.

In another exemplary embodiment, the decision making component to classify a client into the preemptor or preemptee category may be dynamic, and controlled by pre-assigned rules. Such a rule could be, for example, the length of access time needed to the memory. Thus, a given client could be classified in one group or another group depending on the transaction that is needed.

In another exemplary embodiment, three or more sequencers may be used according to the present subject disclosure. In such a scenario, there would be pre-determined rules as to which sequencer would have priority over the others.

The examples and methods described above are not limited to software or hardware, but may be either or a combination of both. If software, the method described is presented as code in a software program. If hardware, a processor is used to conduct the steps which are embedded within the hardware. The subject matter may also be a combination of software and hardware with one or more steps being embedded within a hardware component, and the other steps being part of a software program.

The illustrations and examples provided herein are for explanatory purposes and are not intended to limit the scope of the appended claims. It will be recognized by those skilled in the art that changes or modifications may be made to the above described embodiment without departing from the broad inventive concepts of the subject disclosure. It is understood therefore that the subject disclosure is not limited to the particular embodiment which is described, but is intended to cover all modifications and changes within the scope and spirit of the subject disclosure.

What is claimed is:

1. A method for directing memory transactions, comprising:
receiving a memory transaction request from a preemptor client;
receiving a memory transaction request from a preemptee client; and
proceeding with the memory transaction request of the preemptor client.

2. The method of claim 1, wherein the memory transaction request from the preemptee client was received first.

3. The method of claim 1, wherein if the memory transaction request from the preemptee client was received first and being operated on when the memory transaction request from the preemptor client is received, then the memory transaction request from the preemptee client is ceased until the transaction request from the preemptor client is completed, and then transaction request from the preemptee client is continued.

4. The method of claim 3, further comprising:
decoding a descriptor relating to the memory transaction request from either of the preemptor client or the preemptee client.

5. The method of claim 4, wherein the decoding step is performed by an access sequencer.

6. The method of claim 5, wherein each of the preemptor client and the preemptee client is associated with its own access sequencer.

7. The method of claim 6, wherein each access sequencer communicates with the other access sequencer to determine an order of memory transaction requests.

8. The method of claim 1, wherein the preemptor clients and preemptee clients are predetermined.

9. A method for directing memory transactions, comprising:
receiving a memory transaction request from a preemptor client;
receiving a memory transaction request from a preemptee client;
wherein the preemptor clients and preemptee clients are predetermined; and
wherein if the memory transaction request from the preemptee client was received first and being operated on when the memory transaction request from the preemptor client is received, then the memory transaction request from the preemptee client is ceased until the transaction request from the preemptor client is completed, and then transaction request from the preemptee client is continued

10. A system for directing memory transactions, comprising:
a plurality of client interfaces that receive memory transaction requests from a plurality of clients; and
a plurality of access sequencers;
wherein the access sequencers determine an order of transactions based on the client that sent the memory transaction request.

11. The system of claim 10, wherein the clients are classified as preemptors and preemptees, with the memory transaction request from the preemptor client always preempts the memory transaction request from the preemptee client.

12. The system of claim 11, wherein the preemptor clients and preemptee clients are predetermined.
